(19) United States
(12) Patent Application Publication
(10) Pub. No.: US 2003/0233221 A1
(43) Pub. Date: Dec. 18, 2003

(54) JTAG server and sequence accelerator for multicore applications

(76) Inventors: James J. O'Brien, Hull, MA (US); Stephane A. Billard, Weymouth, MA (US)

Correspondence Address: SAMPSON & ASSOCIATES, P.C., 50 CONGRESS STREET, BOSTON, MA, 02109, US

(21) Appl. No.: 10/281,020

(22) Filed: Oct. 25, 2002

Related U.S. Application Data
(63) Continuation-in-part of application No. 10/160,914, filed on Jun. 3, 2002.

(51) Int. Cl. G06F 9/455

(52) U.S. Cl. 703/23

(57) ABSTRACT

A method and system is provided for emulating individual JTAG devices in a multiple device boundary scan chain. One or more target devices within the scan chain are selected, and other devices within the scan chain may be placed into bypass mode. Packets associated with particular emulation sequences are sent to a server, and subsequently sent to an accelerator which buffers the packets in a first memory device until a sequence is completed. The completed sequence is then transmitted to the scan chain, while packets associated with another sequence are concurrently buffered in another memory device in the accelerator. The emulation sequences sent to the target bypass the other device(s) and are executed by the target device(s).

### RELATED APPLICATIONS

This application is related to U.S. patent application Ser. No. 09/921,250, entitled Multiple Device Scan Chain Emulation/Debugging, filed Aug. 2, 2001, which claims the benefit of U.S. Provisional Application Ser. No. 60/252,316, filed Nov. 21, 2000. This application is also related to U.S. patent application Ser. No. 10/083,224, entitled Multi-Core Controller filed Feb. 26, 2002. This application is a Continuation-In-Part of U.S. patent application Ser. No. 10/160,914, entitled JTAG Server, filed Jun. 3, 2002.

### BACKGROUND

JTAG (Joint Test Action Group) Boundary Scan Architecture has been used for many years to enable convenient testing of multiple board-mounted devices. This architecture utilizes the concept of placing a series of cells forming a serial shift register, around the boundary of a device. This shift register is known as a boundary-scan register. The JTAG Boundary Scan Architecture has been standardized in an international standard known as the IEEE 1149.1 “Test Access Port and Boundary-Scan Architecture”. As used herein, the terms “JTAG”, “JTAG compliant”, and/or “IEEE 1149.1” are interchangeably used to refer to this standard (including subsequent revisions and modifications thereof) and/or devices that are compliant with this standard.

The boundary-scan cells forming the boundary-scan register essentially formed a series of “virtual nails”, which may be used to test the presence, orientation, and bonding of devices in place on a board. In particular, the prime function of the bed-of-nails in-circuit tester, and thus, the boundary-scan architecture, has been to test for manufacturing defects, such as missing devices, damaged devices, open and short circuits, misaligned devices, and wrong devices. JTAG Boundary Scan Architecture is discussed in greater detail in U.S. patent application Ser. No. 09/921,250, entitled Multiple Device Scan Chain Emulation/Debugging, filed Apr. 2, 2001 (the '250 application), which is fully incorporated by reference herein.

With the proliferation of complex board mounted systems, it became desirable to effect in-depth testing of individual components. A method and apparatus for emulating and/or debugging individual devices using scan chain architecture was disclosed in the '250 patent application.

A need exists, however, for a tool that provides the ability to conveniently access multiple devices on a single scan chain ring for various reasons, such as to control and manipulate multiple devices, and to have multiple debug sessions active simultaneously. In addition, it is desirable for this tool to have the ability to load FPGAs, EPLDs (Erasable Programmable Logic Device), and other programmable devices, to reduce or eliminate the need for multiple device programmers and emulation hardware.

However, sending and receiving individual instructions to and from a particular target processor may be undesirably delayed in the event the target processor is disposed within a relatively large scan chain. Thus, a further need exists for improving the speed at which JTAG compliant instructions may be communicated with a target device in a scan chain.

### SUMMARY

One aspect of the present invention includes a system for emulating individual JTAG devices in a multiple device boundary scan chain. The system includes a topology module configured to obtain the topology of the scan chain, and a selection module coupled to the topology module, the selection module being configured to select a target device within the scan chain. An emulation instruction module is configured to generate emulation packets configured for execution by the target device. The system also includes a JTAG accelerator including a first memory device, a second memory device, and a sequence controller controllably coupled to the first and second memory devices. The system also includes a server having a record module, the server being configured to record the emulation packets in the record module, and to transmit the emulation sequences from the record module to the sequence controller. The sequence controller is configured to receive JTAG packets from the record module and send the packets to the first and second memory devices, each of the memory devices being configured to receive and buffer JTAG packets until a complete JTAG sequence is stored therein. The sequence controller is configured to retrieve a completed JTAG sequence from one of the first and second memory devices and transmit the completed JTAG sequence to the target device while simultaneously transmitting packets to an other of the first and second memory devices.

Another aspect of the invention includes a system including a JTAG sequence module configured to generate JTAG packets configured for execution by a target device in a multiple device scan chain, and a JTAG accelerator coupled to said sequence module. The JTAG accelerator includes a sequence controller, and first and second memory devices communicably coupled to the sequence controller. A JTAG output port is coupled to the accelerator.

Another aspect of the invention includes either of the foregoing aspects and a graphical user interface (GUI) for an emulator configured to emulate individual devices in a multiple device chain. The GUI includes a user-selectable list of devices, a graphical display of the chain, at least one chain parameter field, and a session field configured for identifying each of a plurality of emulation sessions.

In another aspect of the present invention, a method includes generating JTAG packets with a JTAG sequence module, the packets being executable by a target device in a multiple device scan chain, receiving the JTAG packets with a sequence controller, and sending first JTAG packets associated with a first sequence, from the sequence controller to a first memory device. The method further includes storing the first JTAG packets in the first memory device until substantially the entire first sequence is stored therein, retrieving the first sequence with the sequence controller, and transmitting the first sequence via a JTAG output port. Second JTAG packets associated with a second sequence are sent from the sequence controller to a second memory device, and stored in the second memory device until substantially the entire second sequence is stored therein. The second sequence is retrieved with the sequence controller, and transmitted to the second sequence via the JTAG output port. The packets of the second sequence are sent to the second memory device simultaneously with transmitting the first sequence via the output port.

A further aspect includes a method for emulating individual devices in a multiple device chain. The method includes selecting at least one target device within the chain, actuating a server having a record module, and creating emulation packets associated with sequences configured for execution by the at least one target device. This method further includes recording the emulation packets in the record module, and transmitting the recorded emulation packets to an accelerator having a first memory device, a second memory device, and a sequence controller controllably coupled to the first and second memory devices. The packets are received at the controller, and transmitted to one of the first and second memory devices. The packets are buffered within one of the first and second memory devices until a complete sequence is stored therein. The complete sequence is retrieved from the one memory device and sent to the target device, so that the sequence passes at least one other device on the scan chain and is executable by the target device. During the retrieving, packets are transmitted to an other of the first and second memory devices.

In a still further aspect, an article of manufacture is provided for emulating individual JTAG devices in a multiple device boundary scan chain. The article of manufacture includes a computer usable medium having a computer readable program code embodied therein. The computer readable program code includes instructions for selecting at least one target device within the chain, actuating a server having a record module, creating emulation packets associated with sequences configured for execution by the at least one target device, recording the emulation packets in the record module, and transmitting the recorded emulation packets to an accelerator having a first memory device, a second memory device, and a sequence controller controllably coupled to the first and second memory devices. Computer readable program code is also provided for receiving the packets at the controller, transmitting the packets to one of the first and second memory devices, buffering the packets within the one of the first and second memory devices until a complete sequence is stored therein, and retrieving a complete sequence from the one of the first and second memory device and sending the complete sequence to the target device, wherein the sequence passes at least one other device on the scan chain and is executable by the target device. The program code also transmits packets to an other of the first and second memory devices during the retrieving.

### BRIEF DESCRIPTION OF THE DRAWINGS

The above and other features and advantages of this invention will be more readily apparent from a reading of the following detailed description of various aspects of the invention taken in conjunction with the accompanying drawings, in which:

FIG. 1 is a schematic representation of system under test using an embodiment of the present invention;

FIG. 2 is a functional block diagram of an emulator which incorporates an embodiment of the present invention;

FIGS. 3 and 4 are schematic representations, on an enlarged scale, of portions of the embodiment of FIG. 2;

FIGS. 5A and 5B are a flow chart of various operations performed by embodiments of the present invention;

FIGS. 6-10 are screen displays of a graphical user interface of an embodiment of the present invention;

FIGS. 11 and 12 are screen displays of a graphical user interface of an alternate embodiment of the present invention;

FIGS. 13-14 are functional block diagrams of alternate embodiments of the present invention; and

FIG. 15 is a flow chart of various operations performed by embodiments of the present invention.

### DETAILED DESCRIPTION

Referring to the figures set forth in the accompanying drawings, the illustrative embodiments of the present invention will be described in detail hereinbelow. For clarity of exposition, like features shown in the accompanying drawings shall be indicated with like reference numerals and similar features as shown in alternate embodiments in the drawings shall be indicated with similar reference numerals.

Embodiments of the present invention include a JTAG server 108 for use in a tool (e.g., an emulator) 110, which enables devices on a multiple device scan chain ring to be individually targeted and controlled or otherwise manipulated. For example, the devices may be targeted for emulation/debugging operations. Tool 110, equipped with JTAG server (or layer) 108, advantageously enables multiple debug sessions to be active simultaneously. As used herein, the term ‘session’ refers to a connection and/or series of communications between the tool 110 and an individual device, such as for example, a debugging session. These multiple debug sessions may include multiple debug sessions on a single host system 112, or on unique systems 112, 114. Moreover, the tool may be used to load FPGAs, EPLDs, and other programmable devices, to nominally eliminate the need for having additional discrete programming and/or emulating tools.

Embodiments of tool 110 may be directly coupled to a host system, such as by incorporation of the tool into the visionPROBE™ hardware-assisted debugging & test tool products available from Wind River Systems, Inc. (Wind River) of Alameda, Calif. Alternatively, tool 110 may be accessed via a network, such as by incorporation of the tool 110 within the visionICE™ real-time in-circuit emulator, also available from Wind River Systems, Inc.

Embodiments of the present invention utilize JTAG compliant instructions (also referred to as sequences), as set forth in the above-referenced '250 application, that utilize conventional boundary scan input and output cells to selectively bypass individual devices in the serial scan chain ring, to enable one or more selected devices to be coupled through the scan chain ring to the emulator/debugger 110. Examples of JTAG enabled (also referred to as JTAG compliant) devices that may be used in conjunction with embodiments of the present invention include the 6xx, 7xx and 82xx family of processors available from Motorola® (Palatine, Ill.), as well as Mcore (Motorola), POWERPC® (International Business Machines Corporation ‘IBM’, Armonk, N.Y.), 4xx (IBM), MIPS® (Mips Technologies, Inc., Mountain View Calif.), Xscale (Intel), and ARM (Arm Limited, Cambridge, England) processors.

Embodiments of the present invention may be used with other types of devices, such as IEEE 1149.1 compatible devices capable of in-circuit PAL, FLASH, FPGA, and EPLD programming. These alternative embodiments may provide features such as boundary scan signal display and in-circuit testing.

Where used in this disclosure, the term “emulator” is used in a manner familiar to those skilled in the art, namely, to refer to hardware and/or software configured to enable a host processor to run software designed for a target processor, and which may include a source-level debugger. For example, the term “emulator” may include the aforementioned visionICE™ real-time in-circuit emulator, and/or visionPROBE™ hardware-assisted debugging & test tool products available from Wind River, alone or in combination. Such an emulator, modified in accordance with embodiments of the present invention as described herein, is referred to as “emulator 110”.

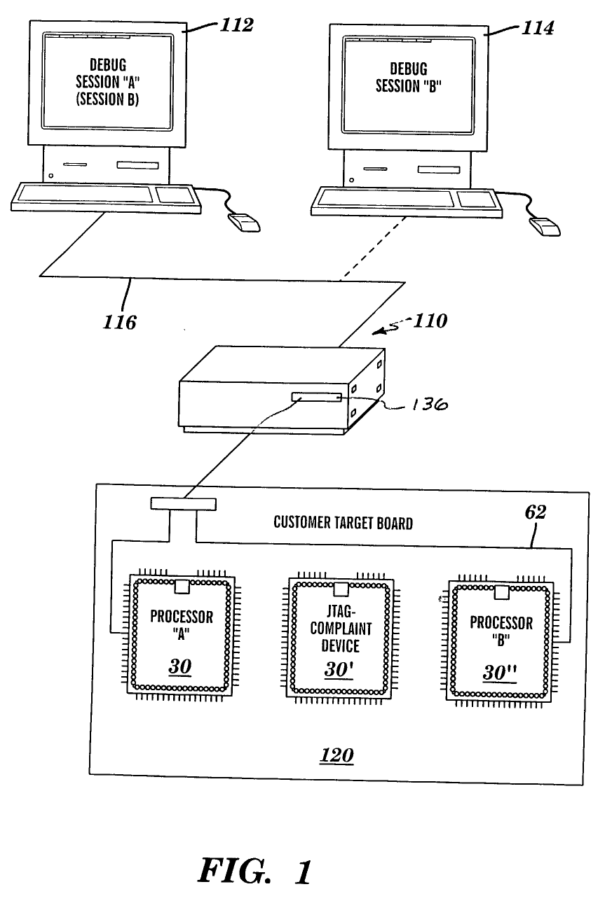

Referring now to Figures, embodiments of the present invention will be more thoroughly described. Turning to FIG. 1, in an exemplary embodiment, one or more discrete host systems 112, 114, are connected via connection 116 to an emulator 110. The emulator is connected to a target board 120 which, in this example, includes three devices on a single scan chain 62, namely, two processors 30, 30″, and an FPGA 30′.

Host systems 112, 114 may include a PC, workstation, terminal, or other similar device having a user interface such as a display and some form of input device (e.g., keyboard, mouse, touch screen, etc.). Connection 116, as mentioned hereinabove, may include a direct connection to a parallel port or USB port of a PC 112, 114. In this configuration, emulator 110 may be embodied in the VisionPROBE™ tool described above. Alternatively, connection 116 may include a network (e.g., LAN, WAN, or Internet), such as connected to systems 112, 114 via an Ethernet port or the like. In this latter configuration, emulator 110 may be embodied within the VisionICE™ tool.

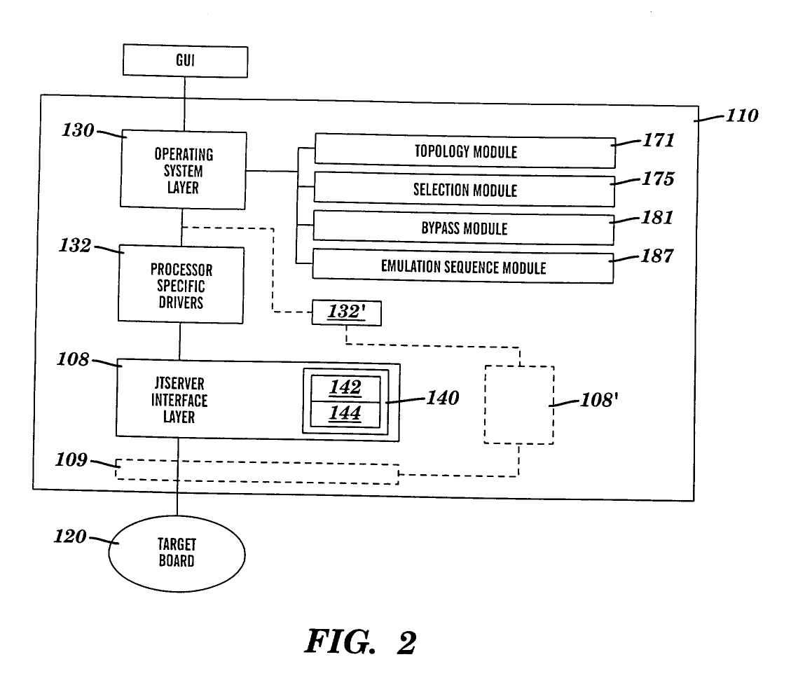

Advantageously, the configuration shown in FIG. 1 may be used to interface two source level debug sessions (e.g., one session for each host system 112, 114), and to provide programmability for the FPGA. This functionality is provided by JTAG server 108 (FIG. 2) which in particular embodiments, is a low level software layer disposed between the target board and the processor-specific drivers, as will be described in greater detail hereinbelow. This layer 108 provides the control needed to position data correctly onto the scan chain 62 in compliance with the IEEE 1149.1 specification for multiple devices on a single scan chain. Layer 108 provides this control in part, by using the topology of the scan chain 62 to determine the position of instructions within a data stream.

This use of the scan chain topology to tailor the bit stream is described in detail in the above-referenced '250 application. Briefly described, this approach includes creating a board description file which specifies the topology of the target board's scan chain layout. This file may be generated manually, i.e., by direct user input, or may be generated by a high level GUI application such as that of the visionCLICK™ (Wind River) or visionXTREME™ (Wind River) tool. An exemplary board description file (in XML format) is shown in Table 1 below:

TABLE 1

<DEVICE_TABLE MODE=“SLOW” CLOCK=“12mhz”
MULTI=“ENABLE”>

<!− −This is a sample board description file.− −>
<!− −Set the MODE to SLOW for now− −>
<!− −Set TCLK to 12 mhz− −>
<!− −Enable MULTIple devices on a chain− −>
<DEVICE>

<NAME> PPC750 </NAME>
<DESIGNATOR> U1 </DESIGNATOR>
<TYPE> CPU_A </TYPE>
<IR_LEN> 8 </IR_LEN>

</DEVICE>
<DEVICE>

<NAME> XC9536XL </NAME>
<DESIGNATOR> U2 </DESIGNATOR>
<TYPE> FPGA </TYPE>
<IR_LEN> 9 </IR_LEN>

</DEVICE>
<DEVICE>

<NAME> PPC750 </NAME>
<DESIGNATOR> U3 </DESIGNATOR>
<TYPE> CPU_B </TYPE>
<IR_LEN> 8 </IR_LEN>

</DEVICE>
<DEVICE>

<NAME/>
<DESIGNATOR/>
<TYPE/>
<IR_LEN/>

</DEVICE>

</DEVICE_TABLE>

The board description file of Table 1 describes the three devices that comprise the topography of board 120 in FIG. 1. The first device 30, is designated CPU_A, and has an instruction register length of 8 bits. The second device 30′ is an FPGA with an instruction register length of 9 bits. The third device 30″ is CPU_B, which has an instruction register length of 8 bits. The total Instruction Register (IR) length of the scan chain 62 is 25 bits. The location of each device in the scan chain may be determined based on its position in the board description file.

In the embodiments shown, server 108 is instantiated, or otherwise actuated, once for each session, e.g., once for each device to be controlled. Multiple instances of server 108 may be used to control multiple sessions for one or more devices. The skilled artisan will recognize that any number of instances of server 108 may be used, provided emulator 110 has sufficient hardware resources available.

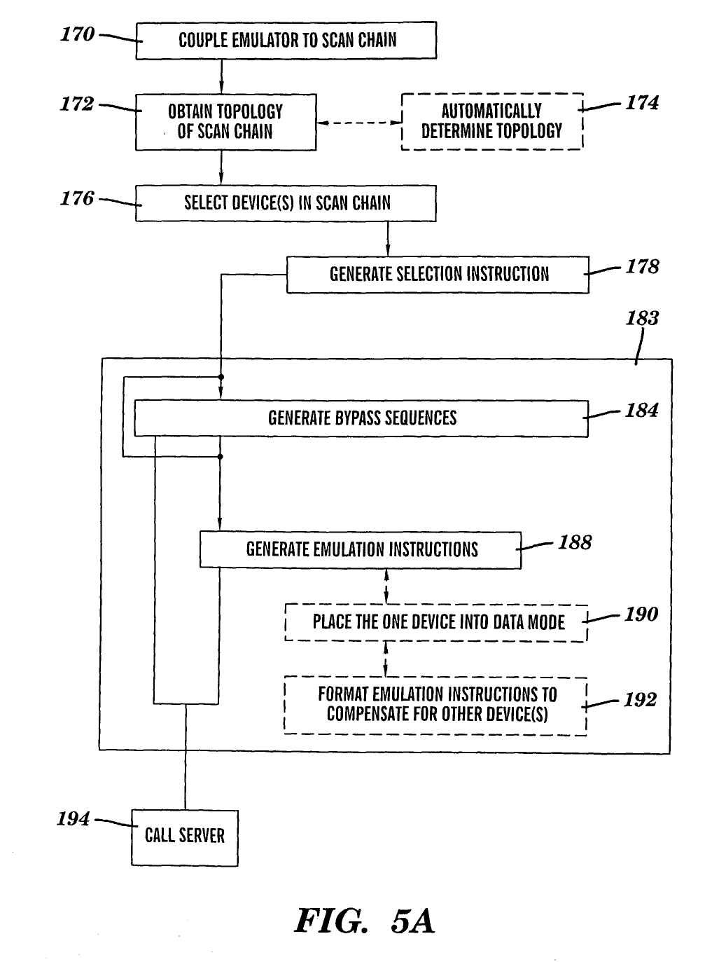

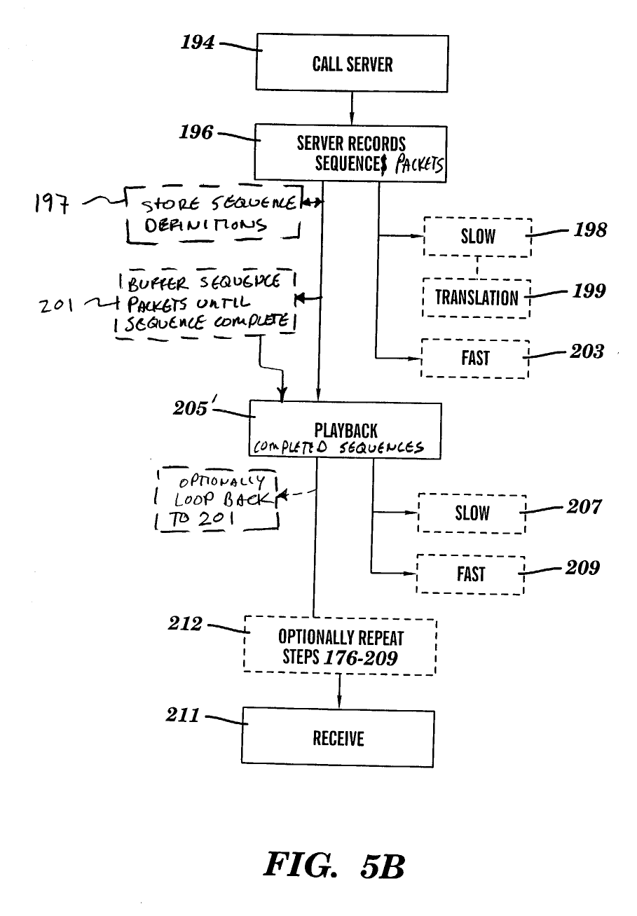

Turning now to FIG. 2, emulator 110 and server 108 are described in greater detail. As discussed hereinabove, server or layer 108 is disposed between the target board and the higher layers of the system such as the operating system (OS) layer 130 of emulator 110. OS layer 130 controls data flow to and from all external communication devices (including host system 112, 114 of FIG. 1). OS 130 also controls the data flow to and from the target board 120, i.e., via processor-specific drivers (also referred to as driver layer) 132. In the embodiment shown, OS layer 130 includes a topology module 171 configured to obtain 172 (FIG. 5A) the topology of the scan chain, and a selection module 175 configured to select 176 (FIG. 5A) at least one target device within the scan chain. Optionally, a bypass module 181 is configured to generate bypass sequences 184 (FIG. 5A) to place at least one other device within the scan chain into bypass mode. An emulation sequence module 187 is also included, to generate 188 (FIG. 5A) emulation sequences for transmission to the scan chain where they bypass the unselected device(s) and are executed by the target device(s), as will be discussed in greater detail hereinbelow with respect to FIGS. 5A and 5B.

As shown, driver layer 132 is logically located beneath the OS layer, and includes specific sequences used to interface the OS layer 130 to the target board 120. These driver sequences are specific to the particular processor manufacturer, and typically include sequences familiar to those skilled in the art, such as those used to access Instruction and Data Registers of the particular devices. Multiple instances of driver layer (e.g., multiple drivers) 132 may be used to interface multiple devices 30, 30′, 30″, etc.

Server (also referred to as server interface layer) 108, is logically disposed between the driver layer 132 and target board 120, to provide an additional level of control. Server 108 receives control sequences from the processor-specific driver 132 and loads each sequence into a high-speed buffer 140, which includes a transmit buffer 142 and a receive buffer 144. Buffer 140 may be implemented in hardware, software, or a combination thereof. Buffer 140 may be integrated within server 108, 108′, as shown, or alternatively, may be disposed as a discrete component communicably coupled to the server.

The Server 108 operates using a notional record and playback strategy. During operation, Server 108 receives sequences from the driver layer 132, and processes each sequence by loading them into transmit buffer 142. Once the sequences for a specific task are loaded, the Server transmits (e.g., ‘plays back’) the contents of transmit buffer 142 to target 120. Similarly, data (e.g., responsive data) generated by target 120 may be received by receive buffer 144. Examples of such received data include status data (e.g., of a register), memory data, or register data.

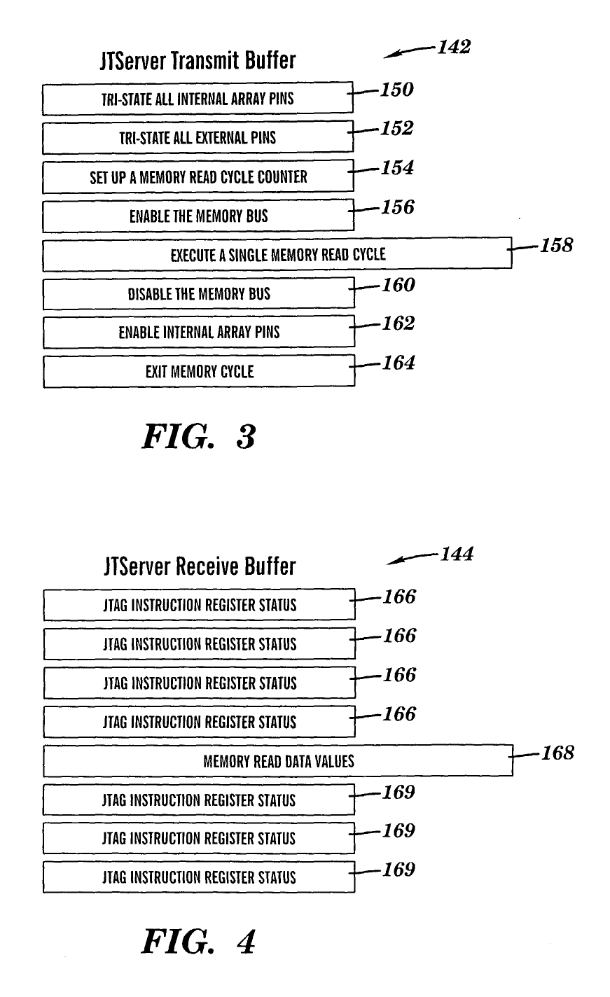

An exemplary task performed by Server 108 is shown and described with reference to FIGS. 3 and 4. For example, server 108 may be used to effect the task of taking read data from a memory location on the target board 120. For commercially available JTAG compliant processors, this task generally requires multiple sequences of preparation followed by implementation of a memory read cycle, followed again by multiple sequences that place the processor back into its normal state.

As shown in FIG. 3, a typical ‘memory read’ task requires four short setup or control JTAG sequences prior to the memory read sequence. In the ‘memory read’ example, these sequences include: tri-stating all internal array pins 150; tri-stating all external pins 152; setting up a memory read cycle counter 154; and enabling the memory bus 156. The memory read sequence 158 is followed by three more short sequences used to place the processor back to its normal state. These three sequences include: disabling the memory bus 160; enabling internal arrays 162; and exiting the memory cycle 164. Once all of these sequences are loaded into transmit buffer 142, they are transmitted to target 120.

In general, for each sequence executed, the target 120 will generate a response. The receive buffer 144 collects these responses as shown in FIG. 4. In the memory read example discussed above, since the first four transmitted sequences 150, 152, 154, 156, were for setup or control, the first four responses received by receive buffer 144 are respective JTAG Instruction Register status responses 166. The response to the memory read sequence 158 contains the memory read data values 168 from the memory of target 120. JTAG Instruction Register Status responses 169 are received in responses to sequences 160, 162, 164.

Referring again to FIG. 2, as mentioned hereinabove, although the foregoing description shows and describes a single instance of driver 132 and server 108, in alternate embodiments, additional drivers 132′ and/or servers 108′ (as shown in phantom) (including buffers, not shown) may be used or instantiated to enable control of multiple devices on a single scan chain 62. In such an event, sequences generated by each server 108, 108′, etc., may be combined, such as by merging module 109, and subsequently transmitted to the target board 120. Discrete commands, data, or other instructions intended for two or more respective targeted devices, may be properly positioned within a single bit stream to reach their intended target. For example, two commands intended for two serially adjacent devices, respectively, are placed serially adjacent to one another within a single bit stream. Similarly, bypass commands may also be appropriately placed within the bit stream to place any other (unselected/non-targeted) devices in the chain into bypass mode. Use of buffer 140, 140′, etc., enables a series of sequences for an individual session to be completed prior to sending them to the scan chain. This may facilitate the use of multiple, nominally simultaneous sessions, by providing a convenient source of combinable sequences for merging module 109.

Referring now to FIG. 5A, an exemplary method for emulating individual JTAG devices in a multiple device boundary scan chain in accordance with the teachings of the present invention is discussed. As shown, this method includes coupling 170 emulator 110 (FIGS. 1 and 5A) to the scan chain, and obtaining 172 the topology of the scan chain, e.g., using topology module 171 (FIG. 2). This obtaining 172 may be effected by the user inputting the information via a GUI, such as those of the visionXTREME™ (Wind River), or visionCLICK™ emulation/debugging tools, running on host system 112, 114, etc. Alternatively, module 171 (FIG. 2) may automatically 174 determine the topology. This information is then used to create the board description file as discussed hereinabove.

The method further includes selecting 176 at least one device 30, 30′, 30″, etc., (FIG. 1) within the scan chain, such as by using selection module 175 (FIG. 2). Selecting 176 may include generating 178 a selection instruction which, using data obtained from the board description file, informs the driver, and/or other system modules, how many IR/DR bypass bits are present before and after (i.e., upstream and downstream of, respectively) the targeted device(s) in scan chain 62 (FIG. 1).

Once the target(s) have been selected, JTAG scan chain sequences, used to communicate with the targeted device(s), are created 183. These scan chain sequences may include any desired combination of instructions and data, to implement desired operations such as debugging or emulation. As described in the above-referenced '250 application, the DEVNUM and associated functionality may be used to place the desired instructions/data at appropriate positions within a bit stream to reach the desired device. The JTAG scan chain sequences may be created using any convenient programming technique available to the skilled artisan. For example, in particular embodiments, a macro language may be used to conveniently define each step required to build the sequences.

The method further includes generating 184 bypass sequences to place at least one other device 30′ in the scan chain 62 into bypass mode, using bypass module 181 (FIG. 2). Emulation sequences may be generated 188 (e.g., using emulation sequence module 187 of FIG. 2) which may then bypass the other device 30′ for execution by the target device(s) 30. In various embodiments, instruction generation 188 may include placing 190 the target device(s) 30 into data mode, and formatting 192 the emulation sequences to compensate for the other device(s).

Referring now to FIG. 5B, once a sequence is created 183, the device driver calls 194 the server in order to record 196 the sequence in the buffer 140 (FIG. 2). The recording 196 of a sequence may be completed in one of two modes, i.e., in Slow mode 198 or Fast mode 203. In a particular embodiment, the Slow mode includes storing a copy of the sequences in a macro language, in the memory (buffer 140) of the Server 108. In the Fast mode, the sequences are translated into bit streams that are then stored in buffer 140.

Recording in the Fast mode generally uses fewer system resources, so the recording advantageously completes relatively quickly, and consumes less memory within buffer 140. This advantage pertains because the scan chain sequences only vary from one another by a small percentage of the total number of bits, since most of the bits of the scan chain sequences correspond to control, empty zones, and overhead, associated with proper placement of the instruction/data properly in the sequence. For example, a write to a memory location of a device often requires only a modification of a small percentage (e.g., sometimes as little as about 1-10 percent) of the entire chain sequence relative to other chain sequences directed to the same device.

Thus, during the record phase of a sequence in fast mode 203, information on the pertinent aspects of the sequence, i.e., the instructions/data portion of the sequence, is stored in the Server 108 and linked to the sequence itself. Subsequent sequences may then be recorded simply by substituting a new instruction/data portion into an otherwise identical bit stream.

Once recorded into transmit buffer 142, any sequences recorded in Slow mode 198 (i.e., sequences that were not translated prior to recording) are translated 199 into corresponding bit streams. Then, the sequences associated with a given task may be played back 205. Playback 205 may take place in either Slow mode 207 or Fast mode 209. Fast mode 209 involves transmitting the sequences to the scan chain 62 of the target board 120 in a conventional manner, i.e., typically at as high a data transfer rate as possible. The Slow mode playback 207 is generally a step-by-step operation in which each sequence is transmitted independently, to is enable a user to track the effect of each sequence. It should be evident that the choice of playback modes 207, 209, is nominally independent of the record mode chosen, so that sequences recorded in Slow mode 198 may be played back in Fast mode 209, and vice versa. Steps 176 to 209 may then be optionally repeated 212, to instantiate additional servers 108′ to effect additional sessions as discussed hereinabove.

Responses to the transmitted sequences, such as register status responses 166 and/or data values 169 (FIG. 4) may then be received 211 in receive buffer 144 (FIG. 2). These responses (in bit stream format) are then decoded (e.g., using server(s) 108, 108′ and/or driver(s) 132, 132′), such as by reversing the translation procedure(s) described hereinabove, and sent by OS 130 for display on host system 112, 114.

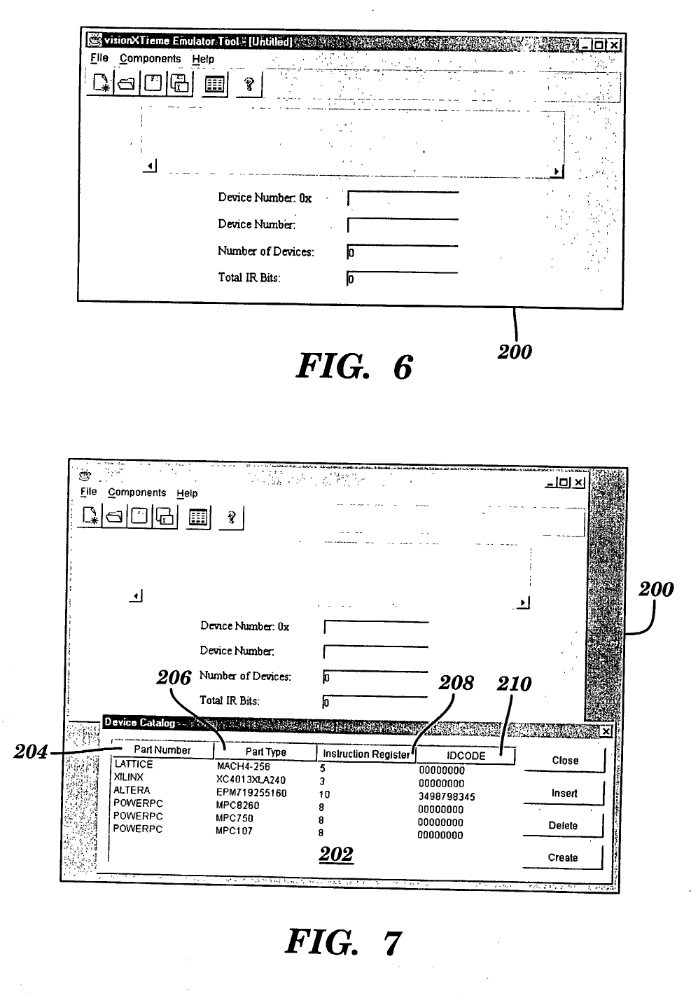

Turning now to FIGS. 6-10, examples of a GUI associated with emulator 110 of the present invention is shown. In this embodiment, the GUI includes the above-referenced visionXTREME™ product modified in accordance with teachings of the present invention.

Referring to FIG. 6, once a user couples emulator 110 to a scan chain 62, 62′, etc., substantially as shown in FIG. 1, to start a new project, the GUI displays a project window 200. The window 200 may be blank, and all data associated to the window may also be blank. Window 200 helps enable the user to define the serial scan chain 62, etc., including the topology thereof, on a particular board 60.

Turning to FIG. 7, the GUI enables the user to select devices from a list (e.g., library) 202. The library 202 includes various devices 30, 30′, etc., listed by manufacturer name 204, type 206, instruction register length 208, and the vector ID code 210. The vector ID code 210 is typically assigned by the manufacturer. The user may select one of the devices 30 from the list, or alternatively, the user may add new devices to the library 202 by entering the corresponding parameters thereof, including the instruction register length 208 and the vector ID code 210.

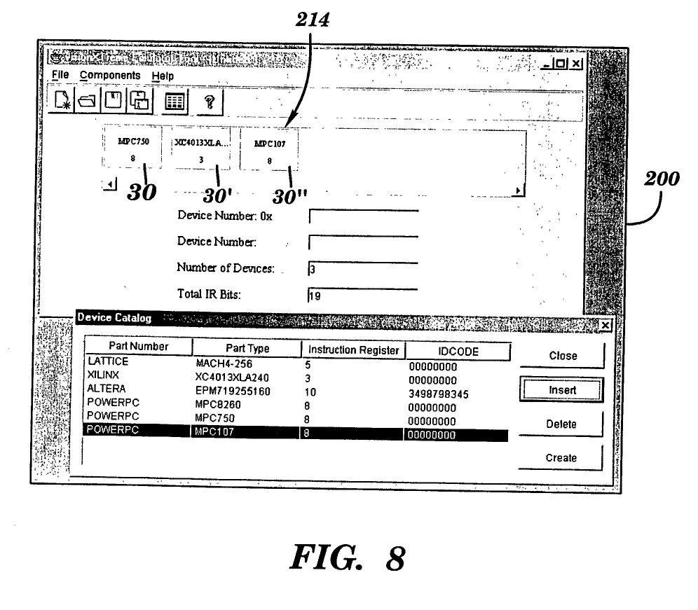

Referring now to FIG. 8, once devices 30, 30′, etc., in the particular scan chain have been added, the project window 200 displays a graphical representation 214 of the topology (e.g., the order of the devices within the scan chain) of the board 60.

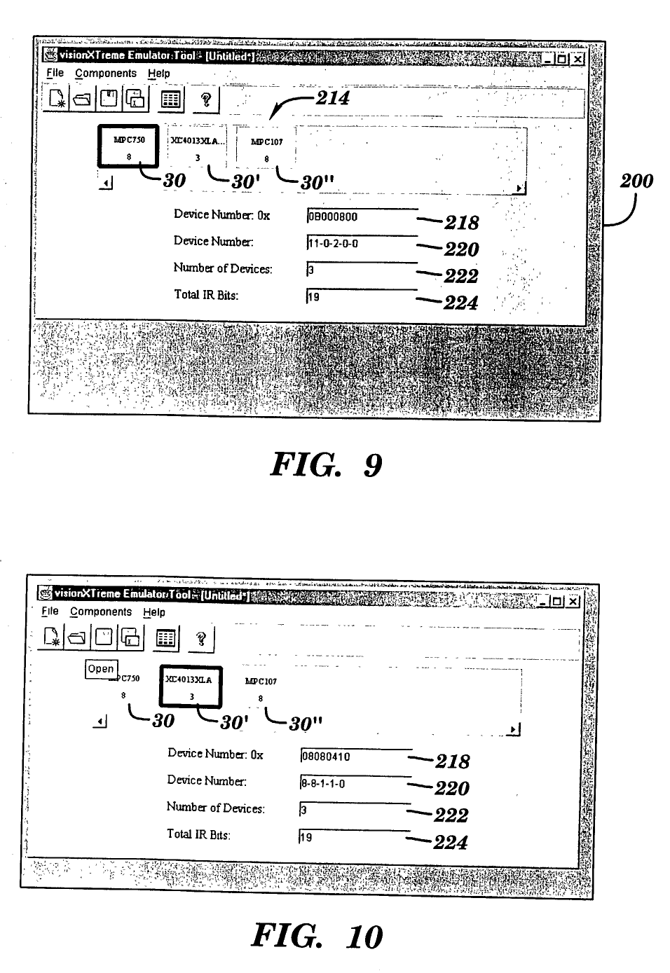

Turning now to FIGS. 9 and 10, the user may select a particular device (e.g., by clicking on the particular device in the graphical representation 214) to display information about this device. In the examples shown, device 30″ was selected in FIG. 9, while device 30′ was selected in FIG. 10. Window 200 may then display the DEVNUM in both hexadecimal and decimal notation in fields 218 and 220, respectively. The total number of devices 30, etc., in the scan chain 62, etc., is shown in field 222, while the total number of instruction register bits in the entire chain is shown in field 224. Once a particular device is selected as shown, emulator 110 places the devices within the scan chain 62, 62′ into their data phases.

The emulator 110 may then generate conventional emulation/debugging commands, which are modified as described hereinabove to compensate for the bits added by the bypassed devices 30′, etc, to properly position the particular commands. The emulator 110 also accounts for bits added by downstream bypassed devices so that the data delivered to the emulator from the selected device 30, etc., may be properly processed. Emulator 110 may now provide emulation/debugging services in a manner consistent with a conventional single chip JTAG emulation environment.

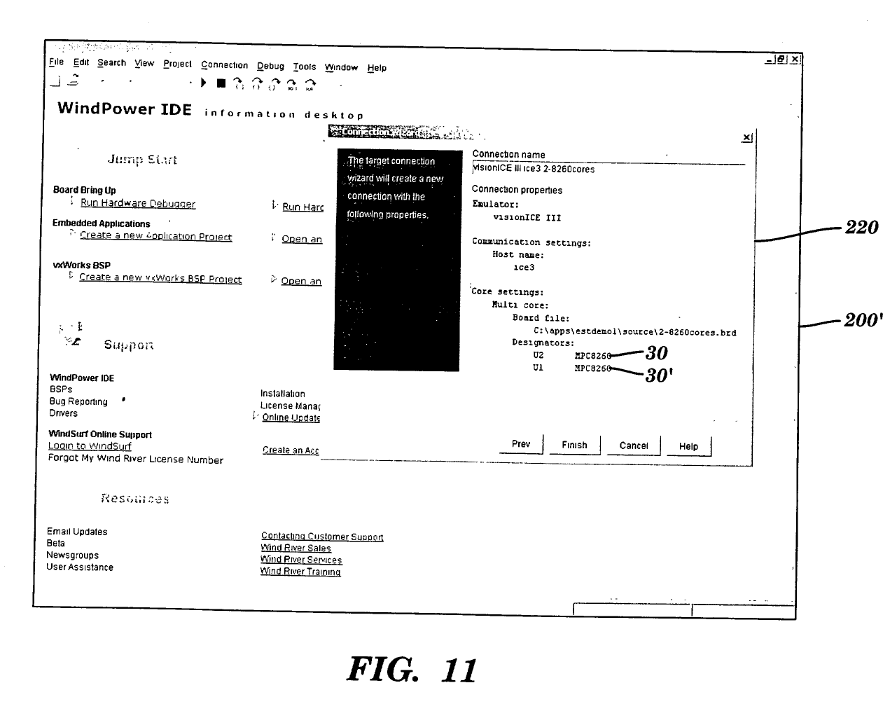

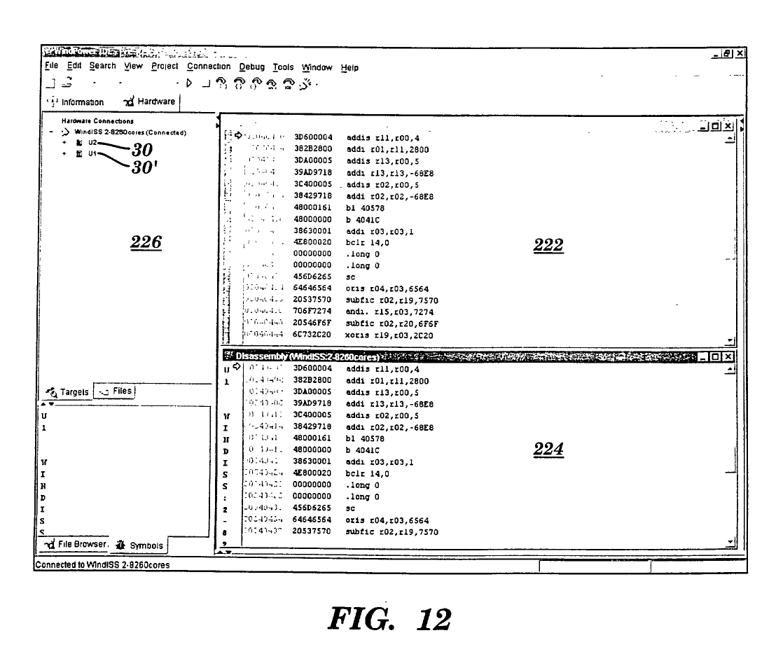

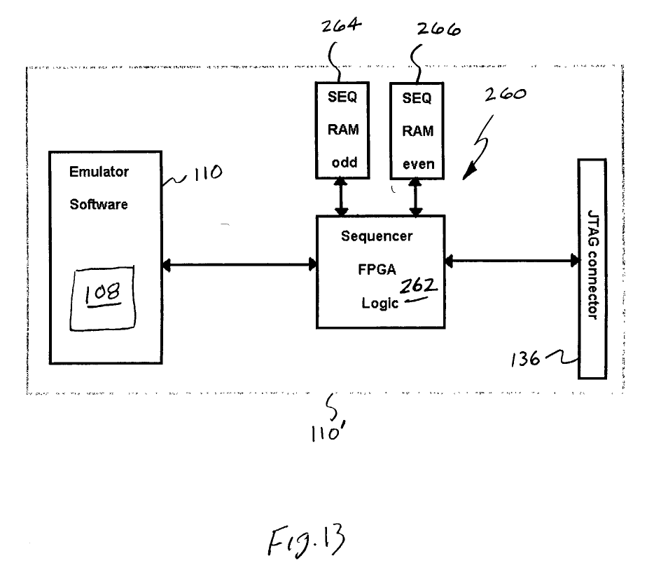

As discussed hereinabove, embodiments of the present invention may be configured to enable multiple sessions to be run simultaneously by instantiating multiple servers 108. A GUI associated with such embodiments is substantially similar to that shown and described with respect to FIGS. 6-10, with variations shown in FIGS. 11 and 12. As shown in FIG. 11, a window 200′ includes a panel 220 (e.g., of a session setup wizard) indicating that sessions for multiple targets 30, 30′ are set up. FIG. 12 shows windows 222, 224, which display the sessions associated with each device 30, 30′, respectively. A target navigator 226 shows each of the target devices that are being debugged/emulated.

Although the GUI of FIGS. 11 and 12 illustrates the implementation of two sessions using a single host 112, the skilled artisan will recognize that greater numbers of simultaneous sessions, may be used without departing from the spirit and scope of the present invention. Moreover, GUIs similar or identical to those described herein may also be used to implement multiple sessions on multiple discreet hosts 112, 114, without departing from the spirit and scope of the present invention.

As mentioned hereinabove, embodiments of the present invention may be used to load programmable devices such as FPGAs and EPLDs. An exemplary approach loading such devices is disclosed in U.S. patent application Ser. No. 10/083,224, entitled Multi-Core Controller, filed Feb. 26, 2002, which is fully incorporated by reference herein. Briefly described, a blank (i.e., unprogrammed/uninitialized) programmable device such as an FPGA 30′ (FIG. 1), typically includes a conventional hardware TAP controller, and blank logic cells (not shown). The TAP controller includes a conventional TRST input, and both the TAP controller and logic cells include conventional parallel TCK, TMS, and TDI inputs and TDO outputs. Once the FPGA 30′ is connected to the emulator 110 through scan chain 62, and via the TAP controller in a conventional manner, the TAP controller may be used to download logic from the emulator 110, via server 108.

Turning now to FIGS. 13-15, alternate embodiments of the present invention include an enhanced JTAG emulator 110′, which includes a JTAG Accelerator 260 to add performance to the aforementioned JTAG emulator 110. As described hereinabove, conventional JTAG emulators generally transfer JTAG packets via a single read and write register controlled by emulator software. Each packet is generally sent at a fixed speed (e.g., determined by the capacity of the medium). The time between packets tends to be relatively long due to the software overhead associated with each packet. In many cases numerous packets must be sent to perform a single operation, which require several calls to the JTAG emulator 110.

JTAG Accelerator 260 may advantageously reduce delay between packets. As shown, an exemplary JTAG Accelerator 260 generally includes a sequence controller 262, such as embodied in an FPGA or similar logic device, and also includes sequence memory devices 264, 266, such as static RAMs, which are configured to hold the sequence data. The sequence controller 262 contains control logic required to operate the memory devices 264, 266 and also includes logic configured to interface with the emulator 110. The controller 262 is also coupled to a JTAG connector (e.g., output port) 136, which is couplable to target board 120 (FIG. 1). As shown, memory devices 264, 266, are grouped into an odd and even (i.e., first and second) format. This allows the emulator 110 to setup (i.e., build and record) a sequence while an other sequence is being transmitted (i.e., played back) 205′ (FIG. 5B) and/or executed. The ODD/EVEN devices 264, 266, have independent control registers that make it possible to keep the tool 110 running nominally without delay between sequences.

In operation, the emulator 110 loads 201 (FIG. 5B) the sequence memory 264 with multiple packets that form a single sequence. When the first sequence is transmitted (i.e., played back) 205′ (FIG. 5B) and begins executing, the tool 110 loops back to begin building a second sequence by loading 201 packets thereof in the other sequence memory 266. Once the second sequence is loaded, logic 262 is informed that once it finishes executing the first sequence (loaded into memory 264), it should begin transmitting/executing the second sequence (loaded into memory 266). This alternating approach continues until all the desired sequences are executed.

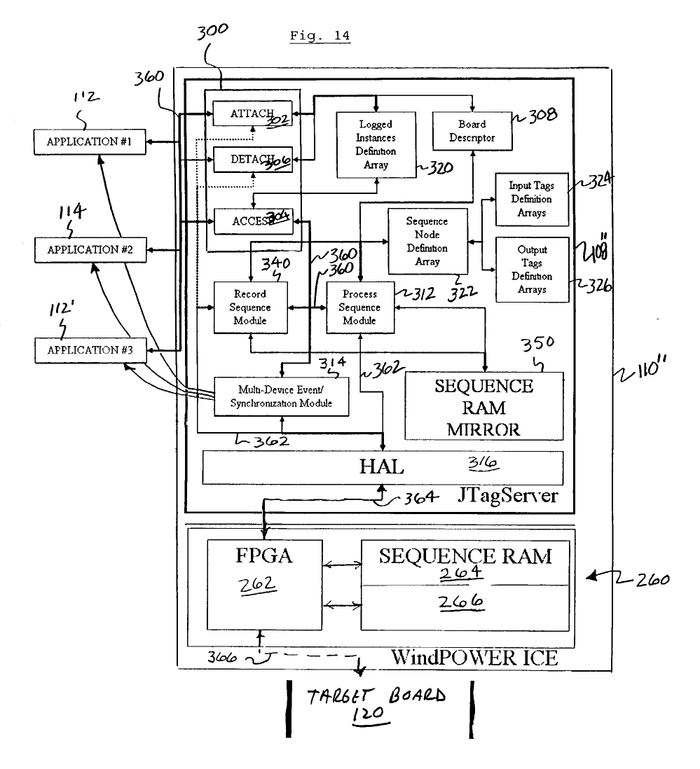

Turning now to FIG. 14, additional aspects of the present invention are shown and described with respect to a further embodiment of the present invention shown as emulator 110″. This emulator 110″ is similar to emulator 110′ described hereinabove, while providing the ability to implement multiple sessions for multiple devices 30, 30′, 30″, etc., using multiple host applications 112, 114, 112′, etc. As shown, emulator 110″ includes various modules linked together to provide an accelerated JTAG Server 108″ interfaced through a single hardware link to a multi-device/multi-core JTAG based Hardware platform (target board) 120.

Among these modules are JTAG Accelerator 260, described hereinabove, and the various modules of JTAG Server 108″, including API Interface Module 300, Record Sequence Module 340, Process Sequence Module 312 (which effects the Transmit and Receive functions of buffers 142 and 144 of FIG. 2), MultiDevice Event/Synchronization Module 314, and Hardware Abstraction Layer Module 316. Additional components, such as shared memory arrays 322, 324, and 326, (discussed hereinbelow) may be provided to effect maintenance and information functions and provide debug entry points to monitor the state of the JTAG Server 108″.

The API Interface Module

As shown, API Interface Module 300 includes three entry points: ATTACH 302, ACCESS 304, and DETACH 306. Together, these serve as the communication layer of JTAG Server 108″, which as shown, communicates with the applications 112, 114, 112′, and with Server 108″, via API Pathways 360.

The ATTACH API entry 302 is the first step taken by an application to access the resources of the JTAG Server 108″. In operation, the first application to attach will provide the board description file (described hereinabove), which is stored at Board Descriptor Array 308. This operation will also trigger the initialization of the hardware interface (e.g., by actuating Hardware Abstraction Layer 316). This action also serves to allocate the shared memory arrays to enable communication between each application instance 112, 114, 112′. (Exemplary shared memory arrays include Board Descriptor Array 308, Logged Instances Definition Array 320, Sequence Node Definition Array 322, Input Tags Definition Array 324, and Output Tags Definition Array 326, which will be discussed in greater detail hereinbelow.)

Moreover, during the ATTACH phase, the application 112, 114, 112′, typically provides various information to the JTAG Server 108″. For example, the application may provide an InstanceId; a default targeted device 30, 30′, startup parameters; and information/event channels (e.g., names/handles for informing each targeted device of an event). This information may be used by Multi-Device Event/Synchronization Module 314 to inform each application of synchronous events such as Target Initialization, Synchronous Start/Stop of all CPUs, and Target Reset (discussed hereinbelow).

Once the ATTACH has been completed, the application 112, 114 may communicate with the JTAG Server 108″ via the ACCESS 304 entry point. The ACCESS 304 API entry point is the gateway for substantially all other JTAG server modules/functions. Access through this gateway is policed via the use of an InstanceId and a FunctionId. The InstanceId informs the JTAG Server 108″ of which application 112, etc., it's communicating with, and the FunctionId acts as a router to redirect the associated information toward the selected target 30, etc. (FIG. 1).

The DETACH 306 API entry point is effectively an exit point for an application 112. An application calling this API call will remove itself from the JTAG Server 108″ and will thereafter not be able to access any modules/functions without re-attaching at ATTACH 302. The last Application to DETACH 306 will shutdown the hardware interface through Hardware Abstraction Layer 316 and free all shared resources.

The Hardware Abstraction Layer Module (HAL)

Hardware Abstraction Layer 316 provides an interface to the debug hardware (e.g., the JTAG Accelerator 260) on the platform on which the JTAG Server 108″ is running. As shown, layer 316 is coupled to various components of server 108″ (e.g., API Interface Module 300, Record Sequence Module 340, Process Sequence Module 312, and Synchronization Module 314) via HAL pathways 262. Hardware Assistance Pathway 364 is used to couple layer 316 to FPGA 262 of Accelerator 260.

In particular embodiments, HAL 316 is responsible for loading the FPGA, (i.e., the desired FPGA Image), which provides access to the RAM 264, 266, and controls pathway 366 to target board 120.

HAL 316 advantageously increases the portability or modularity of the JTAG Server 108″, since adaptation to other (e.g., future) hardware platforms may be effected simply by making adaptations to this layer 316.

Record/Process Sequence Modules

As described hereinabove, the JTAG scan chain instruction sequences are generally created (e.g., by emulation sequence module 187 of FIG. 2) using a macro language which defines the steps used to build the sequences. Once a sequence (or a packet associated with a sequence) is created, a device driver 132 (FIG. 2) calls the JTAG Server 108″ in order to record this sequence/packet using record sequence module 340.

Recording 196 of a sequence is done in either Slow or Fast mode 198, 203, as described hereinabove with respect to FIG. 5B. When a sequence is recorded, information pertaining thereto is stored 197 (FIG. 5B) in the Sequence Node Definition Array 322 and/or Input and Output Tag Arrays 324, 326. Also, in particular embodiments, a copy of the macro language may be copied into the memory (not shown) of JTAG Server 108″ for convenient access and to enable Server 108″ to reconstruct the recorded sequences on the fly without interfering with their respective applications 112, etc.

An exemplary framework for the Sequence Node Definition Array 322 is shown in Table 2 hereinbelow. In this example, array 322 can accommodate up to 1024 JTAG server sequence packet entries. Each entry contains a packet ID, followed by specific information about the packet entry. As shown, each packet entry contains a packet ID (also referred to as a sequence ID), followed by specific information about the packet entry, such as Input and Output TAGs. The packet ID is used by the application 112, 114, to keep track of individual sequence packets. The packet ID may simply include a shorthand notation that identifies the particular operation effected by the sequence, such as reading CPU registers, or issuing a program command to an FPGA. For example, the Sequence ID is used by JTAG Server 108″ during recording 196 (FIG. 5B) to reference each recorded sequence. The ID may also be passed back to the application 112 by Process Sequence Module 312 during playback/transmisstion 205′ and/or receipt 211 of responsive data (FIG. 5B), to provide a quick reference to the particular packet entry. This may be useful when Process Sequence Module 312 plays back sequences that modify the input tags to incorporate dynamic data from the application, and/or recovers data from output tags (during receipt of target data). The sequence ID thus may be used in conjunction with both the Input and Output Tags Definition Arrays 324 and 326.

As mentioned above, Input Tags associated with each sequence are stored for each entry in Table 2. Input Tags Definition Arrays 324 contain, for each Input Tag (and thus for each sequence), the location/size/shape of the data that is to be modified in sequence ram 264, 266 as a result of the particular sequence (e.g., when changing the value of a target register, reading memory from an address, or effecting whatever action is called for by the particular sequence.) The Output Tags and Output Tags Definition Array 326 are used in the opposite manner, to recover information (obtained during receive 211 of FIG. 5B) from the output information generated by the target board (e.g., the TDO) upon execution of the sequence(s).

Typically, scan chain sequences for a basic target 30, 30′ device will require relatively few entries in array 322, while more complex devices may involve 30 or 40 entries. The 1024 entry capacity of the exemplary array 322 of Table 2 should provide enough capacity for even relatively complicated sequence implementations. Moreover, the skilled artisan will recognize that the capacity of array 322, and the various other components and modules of these embodiments may be increased, such as to accommodate future applications, without departing from the spirit and scope of the present invention.

TABLE 2
SEQUENCE DEFINITION ARRAY

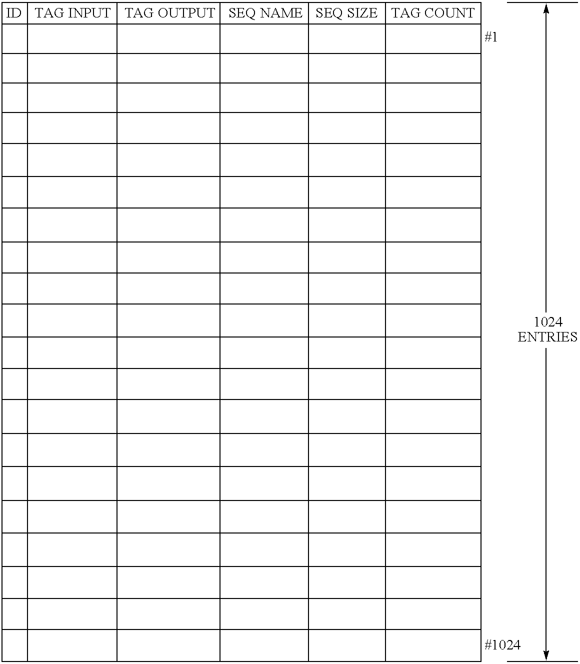

Once recorded into module/buffer 340, any sequences recorded in Slow mode 198 (i.e., sequences that were not translated prior to recording) are translated 199 into corresponding bit streams (as shown in FIG. 5B). Then, the bit-streams for each sequence are stored 201 (FIG. 5B) in at least one sequence ram 264, 266, as described hereinabove with respect to FIGS. 13 & 14, and are stored in a sequence RAM mirror 350. The completed sequences are transmitted (i.e., played back) 205′ to target board 120 by module 312. Playback 205′ is effected substantially as described hereinabove with respect to playback 205, and may also include modifying the input tags to incorporate any dynamic data provided by the application. As also mentioned hereinabove, module 312 also serves to receive 211 (FIG. 5B), and may recover data from the output tags associated therewith, for passing back to the application 112.

In desirable embodiments, a sequence RAM mirror 350, which may include a shared memory array, may be used to optimize operation of sequence RAM 264, 266. Since it is a mirror image, sequence modification may be effected using the mirror 350, and transferred directly to the Sequence Ram 264, 266 via the FPGA logic. This may eliminate the need to Read and Write back the sequence RAM through the FPGA Logic. Reading the Sequence RAM through the FPGA logic, modifying the data and Writing-Back the data to sequence RAM, tends to be time consuming as the sequence RAM is a byte per byte access memory and tool 110″ is manipulating bits.

The structure of each portion 264, 266 of the sequence RAM, and of mirror 350, is shown in Table 3 hereinbelow. Mirror 350 contains two portions (not shown) which are mirror images of portions 264, 266, respectively. Only one portion 264 (and its mirror image), is shown and described with respect to Table 3, with the understanding that the description also applies to portion 266 and its image.

As shown, the Sequence RAM 264 and its Mirror image each contain 3 buffers: TMS, TDI and TDO. These 3 buffers are synchronous to each other, which advantageously enables the sequence RAM 264 to clock TMS and TDI data into the target devices 30, 30′ with the same clock edge. This also enables TDO data to be received on the same clock. In some embodiments, the TDO buffer of the Mirror may not be used. In such an event, the data returned is may be obtained directly from the sequence RAM 264.

TABLE 3
SEQUENCE RAM MIRROR IMAGE

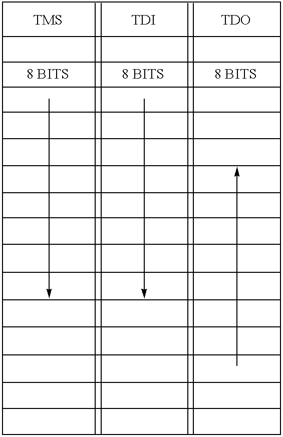

MultiDevice Event/Synchronization Module

This Module 314 is responsible for synchronizing and informing the logged applications 112, 114, 112′, of state changes in the target(s) 30, 30′, etc., (FIG. 1) of target board 120. State changes, (such as synchronized target initialization, or Start/Stop) may be induced by one or more applications 112, 114 (FIG. 14), or by the target 30, 30′, itself. (For example, a target 30 may enter a reset sequence, or may enter a Checkstop exception sequence.) Alternatively, the user may effect a state change via a trigger sequence (e.g., a general target stop may be effected by a signal going low/high. This is typically used in conjunction with use of logic analyzers).

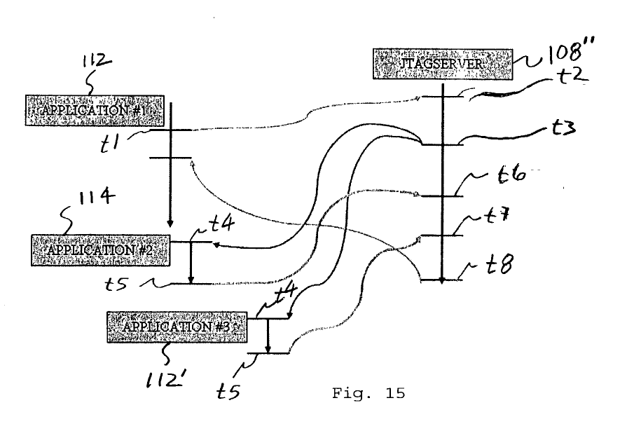

Turning now to FIG. 15, the following is an example of how JTAG Server 108″ handles a synchronous event, with respective timelines. As shown, at time t1, application 112 initiates a synchronous HRESET event which is communicated to JTAG Server 108″. At t2, the server executes conventional JTAG preprocesses required by an HRESET. At t3, server 108″ signals the event to listening applications 114 and 112′, which then process the event at t4. At t5, applications 114 and 112′ process the requested event and send acknowledgments back to server 108″, which as shown, are received at t6 and t7. At t8, Server 108″ generates a signal informing application 112 that applications 114 and 112′ have processed the synchronous HRESET event.

Advantageously, the embodiments of FIGS. 13-15, including accelerator 260, may provide enhanced utilization of system resources for improved processing efficiency by enabling JTAG Server 108″ to effectively pre-process subsequent instruction sequences, while previous sequences are being transmitted and/or executed. Moreover, the use of various shared memory arrays such as arrays 322, 324, and 326, enable Server 108″ to track multiple sets of sequences generated on behalf of multiple applications 112, 114, 112′, etc., to enable a single system 110″ to be handle multiple simultaneous sessions between multiple users and multiple targets.

In the preceding specification, the invention has been described with reference to specific exemplary embodiments thereof. It will be evident that various modifications and changes may be made thereunto without departing from the broader spirit and scope of the invention as set forth in the claims that follow. The specification and drawings are accordingly to be regarded in an illustrative rather than restrictive sense.

Having thus described the invention, what is claimed is:

1. A system for emulating individual JTAG devices in a multiple device boundary scan chain, said system comprising:
a topology module configured to obtain the topology of the scan chain;
a selection module coupled to said topology module, said selection module configured to select a target device within the scan chain;
an emulation instruction module configured to generate emulation packets configured for execution by the target device;
a JTAG accelerator including:
at least a first memory device;
at least a second memory device;
a sequence controller controllably coupled to said first and second memory devices;
a server having a record module;
said server configured to record the emulation packets in the record module;
said server configured to transmit the emulation sequences from the record module to said sequence controller;
said sequence controller configured to receive JTAG packets from said record module and send the packets to said first and second memory devices;
each of said memory devices being configured to receive and buffer JTAG packets until a complete JTAG sequence is stored therein; and
said sequence controller being configured to retrieve a completed JTAG sequence from one of said first and second memory devices and transmit the completed JTAG sequence to the target device while substantially simultaneously transmitting packets to an other of said first and second memory devices.

2. A system, comprising:
a JTAG sequence module configured to generate JTAG packets configured for execution by a target device in a multiple device scan chain;
a JTAG accelerator coupled to said sequence module;
said JTAG accelerator including:
a sequence controller; and
at least first and second memory devices communicably coupled to said sequence controller; and
a JTAG output port coupled to said accelerator.

3. The system of claim 2, wherein said JTAG sequence module comprises an emulator.

4. The system of claim 2, wherein said sequence controller is configured to operate said first and second memory devices.

5. The system of claim 2, wherein said first and second memory devices each comprise random access memory devices.

6. The system of claim 2, wherein said first memory device is configured to store JTAG packets associated with a sequence until the sequence is complete.

7. The system of claim 6, wherein said sequence controller is configured to transmit the completed sequence to said connector for execution by a target coupled thereto.

8. The system of claim 7, wherein said second memory device is configured to store JTAG packets associated with an other sequence during said execution, until the other sequence is complete.

9. The system of claim 8, wherein said sequence controller is configured to transmit the completed other sequence to said connector for execution by a target coupled thereto.

10. A method, comprising:
(a) generating JTAG packets with a JTAG sequence module, the packets being executable by a target device in a multiple device scan chain;
(b) receiving first JTAG packets associated with a first sequence, in a first memory device;
(c) storing the first JTAG packets in the first memory device until substantially the entire first sequence is stored therein;
(d) transmitting the first sequence via a JTAG output port;
(e) receiving second JTAG packets associated with a second sequence, in a second memory device;
(f) storing the second JTAG packets in the second memory device until substantially the entire second sequence is stored therein;
(g) transmitting the second sequence via the JTAG output port;
wherein said transmitting (d) and said receiving (e) are effected substantially simultaneously.

11. A method for emulating individual devices in a multiple device chain, said method comprising:
(a) selecting at least one target device within the chain;
(b) actuating a server having a record module;
(c) creating emulation packets associated with sequences configured for execution by the at least one target device;
(d) recording the emulation packets in the record module; and
(e) transmitting the recorded emulation packets to an accelerator having a first memory device, a second memory device, and a sequence controller controllably coupled to the first and second memory devices;
(f) receiving the packets at the controller;
(g) transmitting the packets to one of the first and second memory devices;
(h) buffering the packets within the one of the first and second memory devices until a complete sequence is stored therein;
(i) retrieving a complete sequence from the one of said first and second memory device and sending the complete sequence to the target device, wherein the sequence passes at least one other device on the scan chain and is executable by the target device; and
(j) during said retrieving (i), transmitting packets to an other of said first and second memory devices.

12. The method of claim 11, comprising:
creating bypass sequences, to place the at least one other device into bypass mode;
recording the bypass sequences in the record module; and
transmitting the recorded bypass sequences from the record module to the scan chain.

13. The method of claim 11, comprising receiving responses from the target device.

14. The method of claim 13, comprising recording the responses in a process module.

15. The method of claim 11, comprising repeating at least one of said steps (a) through (j) to send an other sequence.

16. The method of claim 15, wherein sending the other sequence comprises:
creating other emulation packets; and
tracking the packets for each sequence in a sequence definition array.

17. The method of claim 16, further comprising storing tags associated with the packets in at least one tag definition array.

18. The method of claim 15, wherein at least one of said steps (a) through (j) comprises a session.

19. The method of claim 18, comprising:
coupling a host to the emulator; and
effecting the session using a GUI running on the host.

20. The method of claim 18, comprising coupling the host to the emulator through a network.

21. The method of claim 18, comprising effecting an other session using the GUI.

22. The method of claim 21, comprising effecting an other session for an other target device.

23. The method of claim 18, comprising effecting an other session using an other GUI running on an other host coupled to the emulator.

24. The method of claim 23, comprising selecting the same target device in both the session and the other session.

25. The method of claim 11, wherein the individual devices comprise JTAG devices and the chain includes a boundary scan chain.

26. The method of claim 25, wherein said effecting a session is effected by an emulator.

27. The method of claim 25, wherein said selecting comprises generating a selection instruction and sending the selection instruction to the scan chain.

28. The method of claim 11, wherein said creating emulation sequences comprises creating sequences configured to place the target device into a data mode.

29. An article of manufacture for emulating individual JTAG devices in a multiple device boundary scan chain, said article of manufacture comprising:
a computer usable medium having a computer readable program code embodied therein, said computer readable program code including instructions for:
(a) selecting at least one target device within the chain;
(b) actuating a server having a record module;
(c) creating emulation packets associated with sequences configured for execution by the at least one target device;
(d) recording the emulation packets in the record module; and
(e) transmitting the recorded emulation packets to an accelerator having a first memory device, a second memory device, and a sequence controller controllably coupled to the first and second memory devices;
(f) receiving the packets at the controller;
(g) transmitting the packets to one of the first and second memory devices;
(h) buffering the packets within the one of the first and second memory devices until a complete sequence is stored therein;
(i) retrieving a complete sequence from the one of said first and second memory device and sending the complete sequence to the target device, wherein the sequence passes at least one other device on the scan chain and is executable by the target device; and
(j) during said retrieving (i), transmitting packets to an other of said first and second memory devices.

30. Computer readable program code for emulating individual JTAG devices in a multiple device boundary scan chain, said computer readable program code comprising instructions to perform the following:
(a) selecting at least one target device within the chain;
(b) actuating a server having a record module;
(c) creating emulation packets associated with sequences configured for execution by the at least one target device;
(d) recording the emulation packets in the record module; and
(e) transmitting the recorded emulation packets to an accelerator having a first memory device, a second memory device, and a sequence controller controllably coupled to the first and second memory devices;
(f) receiving the packets at the controller;
(g) transmitting the packets to one of the first and second memory devices;
(h) buffering the packets within the one of the first and second memory devices until a complete sequence is stored therein;
(i) retrieving a complete sequence from the one of said first and second memory device and sending the complete sequence to the target device, wherein the sequence passes at least one other device on the scan chain and is executable by the target device; and
(j) during said retrieving (i), transmitting packets to an other of said first and second memory devices.

31. A system for emulating individual JTAG devices in a multiple device boundary scan chain, said system comprising:
a topology module configured to obtain the topology of the scan chain;
a selection module coupled to said topology module, said selection module configured to select a target device within the scan chain;
an emulation instruction module configured to generate emulation packets configured for execution by the target device;
a JTAG accelerator including:
at least a first memory device;
at least a second memory device;
a sequence controller controllably coupled to said first and second memory devices;
a server having a record module;
said server configured to record the emulation packets in the record module;
said server configured to transmit the emulation sequences from the record module to said sequence controller;
said sequence controller configured to receive JTAG packets from said record module and send the packets to said first and second memory devices;
each of said memory devices being configured to receive and buffer JTAG packets until a complete JTAG sequence is stored therein; and
said sequence controller being configured to retrieve a completed JTAG sequence from one of said first and second memory devices and transmit the completed JTAG sequence to the target device while substantially simultaneously transmitting packets to an other of said first and second memory devices; and
a graphical user interface (GUI) including:
a user-selectable list of JTAG devices;
a graphical display of the chain;
at least one chain parameter field; and
a session field configured for identifying at least one emulation session.
